(19) United States
(12) Patent Application Publication
(10) Pub. No.: US 2016/0266023 A1
(43) Pub. Date: Sep. 15, 2016

(54) UNIT FOR MEASURING THE SETTLING VELOCITY OF PARTICLES IN SUSPENSION IN UNIT FOR MEASURING THE SETTLING VELOCITY OF PARTICLES IN SUSPENSION IN A FLUID AND DEVICE COMPRISING AT LEAST ONE MEASURING UNIT AND ONE AUTOMATIC SAMPLER

(71) Applicants: INSTITUT DE RECHERCHE POUR LE DÉVELOPPEMENT (IRD), Marseille 2 (FR); UNIVERSITE GRENOBLE ALPES (UGA), Grenoble Cedex 09 (FR)

(72) Inventors: Nicolas Gratiot, Grenoble (FR); Bernard Mercier, Saint-Egreve (FR); Cedric Legout, Saint Martin D'uriage (FR); Valentin Wendling, Selestat (FR); Catherine Coulaud, La Tronche (FR); Henri Mora, Renage (FR)

(73) Assignee: Institut de Recherche Pour le Developpement (IRD), Marseille (FR)

(21) Appl. No.: 15/030,238

(22) PCT Filed: Oct. 16, 2014
(86) PCT No.: PCT/FR2014/052646

§ 371 Date: Apr. 18, 2016

(30) Foreign Application Priority Data
Oct. 18, 2013 (FR) 13 60167

(51) Int. Cl. G01N 15/04

(52) U.S. Cl. CPC G01N 15/04; G01N 2015/1075

(57) ABSTRACT

A unit for measuring the falling speed of particles in suspension in a fluid comprises a sealed container having an open compartment containing fluid, and a sealed compartment, and, in the sealed compartment, at least three electromagnetic radiation emitters distributed along a longitudinal axis of the open compartment and oriented according to a radiation axis crossing the open compartment at different heights along the longitudinal axis, an equal number of receivers distributed along the longitudinal axis, each receiver placed in the radiation axis of a corresponding emitter, and a system for acquiring data connected to the receivers which is used to obtain the falling speed of the particles and the change of same as a function of the height in the open compartment and as a function of time, said change quantifying the flocculation of the particles.

The invention relates to the field of devices for measuring the settling velocity of particles in a fluid, such as sediments in water. More particularly, the invention examines the phenomenon of the flocculation of particles.

The areas around watercourses are favoured places for establishing human activities. Their mechanism of sedimentation is therefore of particular interest. In fact, sedimentation can cause a watercourse to change its path, or even to become blocked. It is therefore important to know its effect on a watercourse, for example so as to select the best place for establishing human activities, or so as to be able to take decisions concerning planning. Sedimentation can also store pollutants, fixed to the trapped particles, in undesirable zones.

Sediments are transported over several kilometres by watercourses. They originate for example from the erosion of slopes and/or inputs of organic materials. Then, they are deposited in places where the water is calmer, for example in estuaries (this is then called silting). The concentrations of sediments often exceed 1 g/L, in particular during floods, and may reach up to several hundred grams per litre for mountain rivers, in particular due to the particularly intensive erosion.

The role of the settling velocity of sediments is a key factor for understanding and modelling the dynamics of sediment transport in watercourses. In fact, the settling velocity of the sediments has an influence on the manner in which the sediments are transported.

The settling velocity is affected by the size of the sediments. Moreover, based on the measurement of certain characteristics of the particles such as their size and/or their concentration in the fluid, it is possible to deduce their settling velocity in the fluid, for example from Stokes' law.

There are various techniques for the laboratory measurement of certain characteristics of particles in suspension in a fluid, such as measurements with an Owen tube or with an Andreasen pipette.

Document U.S. Pat. No. 4,696,571 describes an example of a device for measuring the mass and the size of particles in suspension in a liquid. The device comprises a laser directed towards a sample, which is held in a cell of elongated shape. A detector detects the light emitted by the laser and scattered by the sample. The laser is positioned near the bottom of the cell. The sample is shaken and the measurements of scattering are recorded as the particles settle to the bottom.

These techniques are utilized in the laboratory. Samples are taken in situ, and then stored in containers so that they can be transported. Optionally, the samples must be treated prior to transport and storage. Then, the samples undergo further treatment for analysis. In particular, the samples are dried for transport and storage, and then diluted for the laboratory analyses.

The samples can be degraded by drying, distorting the analyses. Moreover, the large number of steps makes these techniques tedious to implement, and expensive. In addition, dilution causes a loss of information about the medium to be analysed.

Furthermore, the conventional techniques are limited once the concentrations of sediments exceed one gram per litre. Now, in particular in mountainous environments, the concentrations of sediments are very high, sometimes reaching several hundred grams per litre. The conventional techniques using a laser do not allow analyses to be carried out at such concentrations.

Devices of the nephelometer type for measuring the turbidity of a fluid in situ also exist. Document U.S. Pat No. 3,364,812 describes an example of this type of device, which comprises a reservoir equipped with an open cover, on which a housing for a lighting system is fixed. A water inlet is provided near the bottom of the reservoir so as to allow a continuous flow of water to an outlet, at a constant level in the reservoir. The surface of the water in the reservoir can then be illuminated by the lighting system through the opening in the cover. A part of the light beam is absorbed by the water and a part is reflected towards calibration means. The light scattered by the water, at about 90°, is collected by a photomultiplier in order to carry out the turbidity measurement. The turbidity is thus measured continuously.

The turbidity measurements described, involving a large volume of measurements, make it possible for example to deduce the concentration of particles. But they do not allow the settling velocity of the particles to be obtained.

Moreover, the size of the sediments varies due to the phenomenon of flocculation.

“Flocculation” is a term used in particular in the area of water treatment to denote a phenomenon in which fine particles in suspension in a liquid agglomerate to form larger particles, called flocs.

Flocculation is of particular importance for studying sedimentation in river basins, since it has an influence on their settling velocity. The greater the flocculation phenomenon, the more the particle size, and therefore their velocity, varies. Flocculation is also particularly important for the transport of pollutants. The particles that are the most flocculating (such as clays), i.e. that have a high flocculating capacity, have a far greater capacity for adsorption of pollutants and nutrients than the non-flocculating particles (such as sands).

The techniques with in situ sampling, transport and then analysis in the laboratory offer poor quantification of the phenomenon of flocculation of a sample. In fact, these techniques that involve drying the samples and/or their dilution alter the particles relative to their state in the original medium, which may mask the phenomenon of flocculation taking place in this medium.

Measuring devices of the nephelometer type only make it possible to determine an average settling velocity, since they start out from the assumption that the particle size does not vary, and therefore that the settling velocity is constant.

A device called a SediMeter® makes it possible to measure the settling velocity of the sediments in situ by directly measuring the variations in height of the layer of sediments. The SediMeter® is in the form of a rod equipped with sensors, one end being inserted into the layer of sediment at the bottom of the watercourse and the other end being in the water.

However, this device cannot provide information on the particles, such as their nature, their size or their concentration. Moreover, this device is difficult to set up, in particular in a watercourse of great depth. Moreover, it can be dragged/pulled out if the currents are strong.

Consequently, there is a need for a new field device for measuring the settling velocity of particles in suspension in a fluid, taking the phenomenon of flocculation into account.

A first subject of the invention is to propose a device for measuring the settling velocity of particles that can be utilized in the field and allows the phenomenon of flocculation of the particles to be taken into account.

A second subject is to propose an inexpensive device for measuring the settling velocity of particles.

A third subject is to propose a device for measuring the settling velocity of particles making it possible to obtain reliable data.

A fourth subject is to propose a device for measuring the settling velocity of particles making it possible to measure the settling velocity of sediments in media reaching, at high concentration, several tens or even hundreds of grams per litre.

A fifth subject is to propose a device for measuring the settling velocity of particles allowing measurements to be taken easily, outdoors, for example beside a watercourse, for times of up to several days, and allowing the device to be moved easily.

For this purpose, according to a first aspect, the invention proposes a unit for measuring the settling velocity of particles in suspension in a fluid from a source. The unit in particular comprises:
a sealed container having an opening, the container defining an open compartment that comprises the opening and a sealed compartment, sealing means separating the open compartment from the sealed compartment, the open compartment being intended to contain a sample of the fluid to be analysed;
means for measuring the settling velocity of the particles of the sample in the open compartment, said measuring means being placed in the sealed compartment of the container.

Said measuring means are of the optical type and in particular comprise:
at least three electromagnetic radiation emitters, the emitters being distributed along a longitudinal axis of the open compartment, each emitter being oriented according to a radiation axis crossing the open compartment at different heights along the longitudinal axis on/over the open compartment;
receivers, the number of which is equal to the number of emitters and which are distributed along the longitudinal axis, each receiver being placed in the radiation axis of an emitter, so as to receive the radiation from the corresponding emitter after passing through the open compartment;
means for controlling the emitters and the receivers;
a system for acquiring data connected to the receivers for collecting the data of the measurements carried out.

The acquired data thus make it possible to obtain the settling velocity of the particles and its variation as a function of the height in the open compartment and as a function of time, said variation quantifying flocculation of the particles.

The measuring unit thus formed then allows field workers to be provided with operational equipment in situ that is robust and complete. The unit makes it possible to obtain reliable measurements, without necessarily requiring the services of the laboratory.

The measuring unit also has the following features, considered alone or in combination:
the data acquired by the measuring means are a measurement of the absorbance of the radiation emitted by the emitters and received by each receiver;
the emitters are of the light-emitting diode type;
the radiation has a wavelength comprised in the infrared. The longitudinal distance between the radiation axis of two successive and adjacent emitters is at most 5 cm;
the longitudinal distance between the radiation axis of two successive and adjacent emitters is 1 cm;
the open compartment is formed by a reservoir introduced into the container, the sealing means being placed between the reservoir and the container;
the bottom of the container is detachable;
the measuring unit comprises means for emptying the open compartment of the at least one measuring unit;

the measuring unit comprises an electrical connector available on the outside of the container, capable of communicating with a data recovery and processing station.

According to a second aspect, the invention relates to a device for measuring the settling velocity of particles in suspension in a fluid from a source. The device comprises:
at least one measuring unit as presented above;
a sampler of the automatic type comprising a fluid inlet that can be connected fluidically with the source of fluid and a fluid outlet connected fluidically with the open compartment of the container of the at least one measuring unit.

In practice, the device comprises a plurality of measuring units. The sampler can be connected fluidically with the open compartment of one measuring unit at a time. The sampler then comprises means for moving and for fluidic connection with the open compartment of at least one other measuring unit, the means for controlling the sampler making it possible to control the filling of the open compartment of one or other of the measuring units. As a variant, the sampler can be connected fluidically simultaneously with the open compartments of several of the measuring units, and the controlling means are able to control the simultaneous filling of the open compartments.

The device comprises for example a tank forming a receptacle for the plurality of measuring units, the sampler being connected fluidically with the open compartment of each of the measuring units.

According to a third aspect, the invention proposes an application of a measuring unit as presented above, in which the fluid is water and the particles are sediments.

Of course, other advantages and features of the invention will become apparent on examination of the detailed description of possible embodiment examples, presented below, and the attached figures in which:

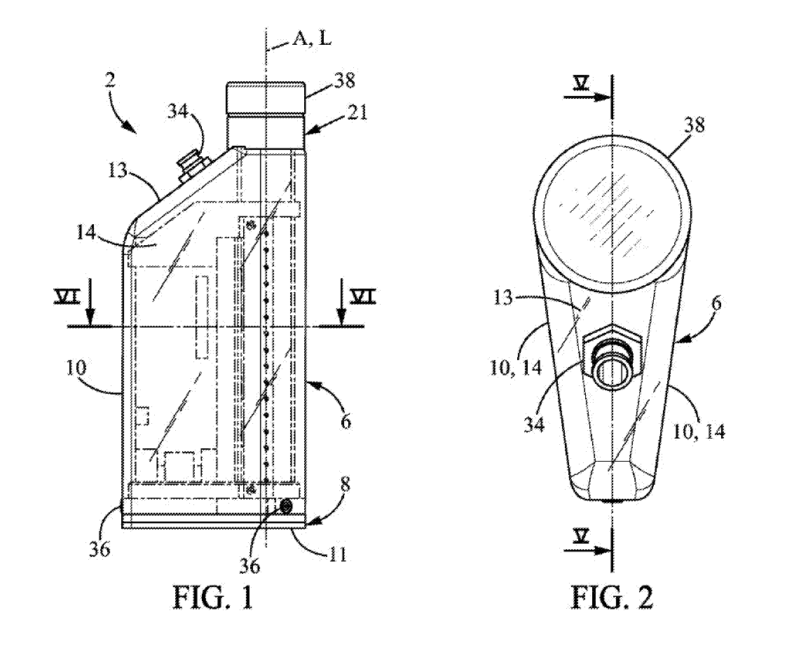

FIG. 1 is a side view of an embodiment example of a measuring unit for a device for measuring the settling velocity of particles in suspension in a fluid, said unit comprising a container;

FIG. 2 is a top view of the unit in FIG. 1;

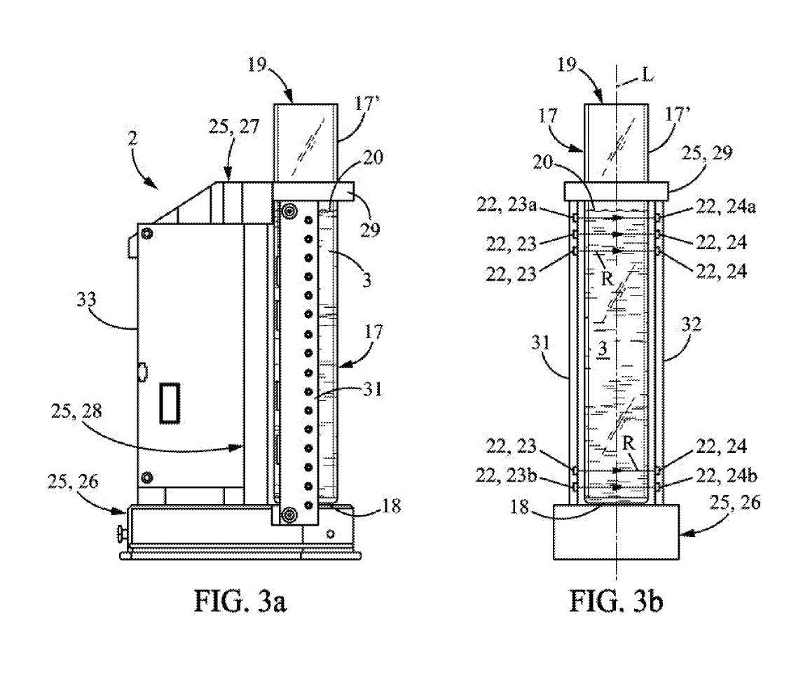

FIG. 3a is a side view of the unit in FIG. 1 without the container;

FIG. 3b is a front view of the unit in FIG. 1 without the container;

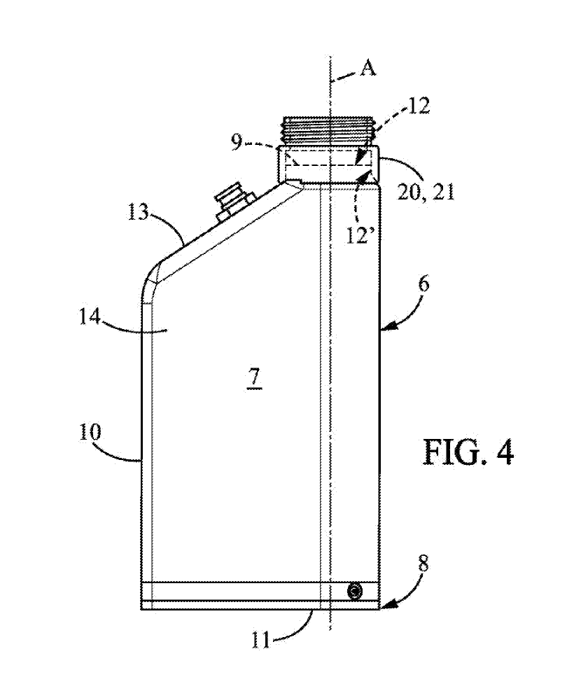

FIG. 4 is a view of the container of the unit in FIG. 1 only;

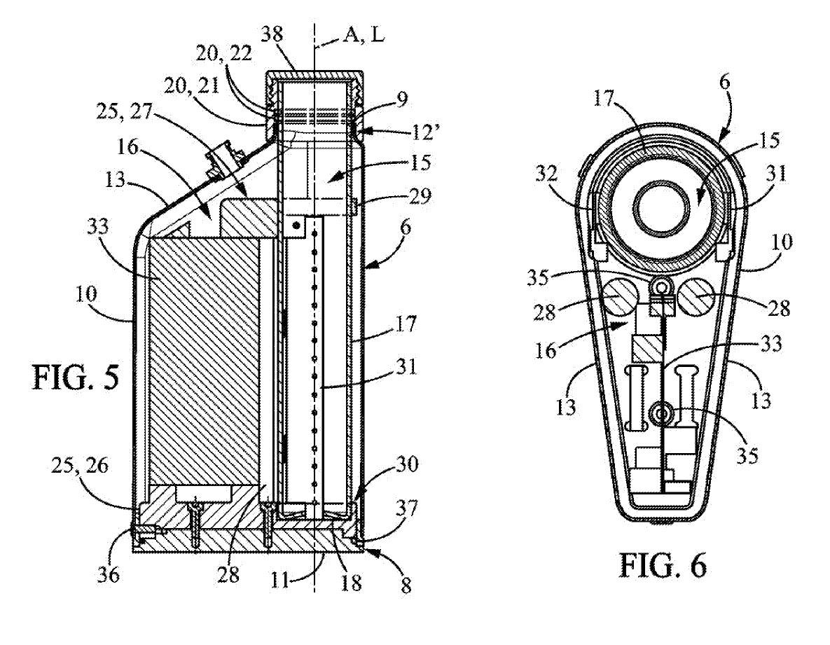

FIG. 5 is a sectional view along V-V of the unit in FIG. 2;

FIG. 6 is a sectional view along VI-VI of the unit in FIG. 1;

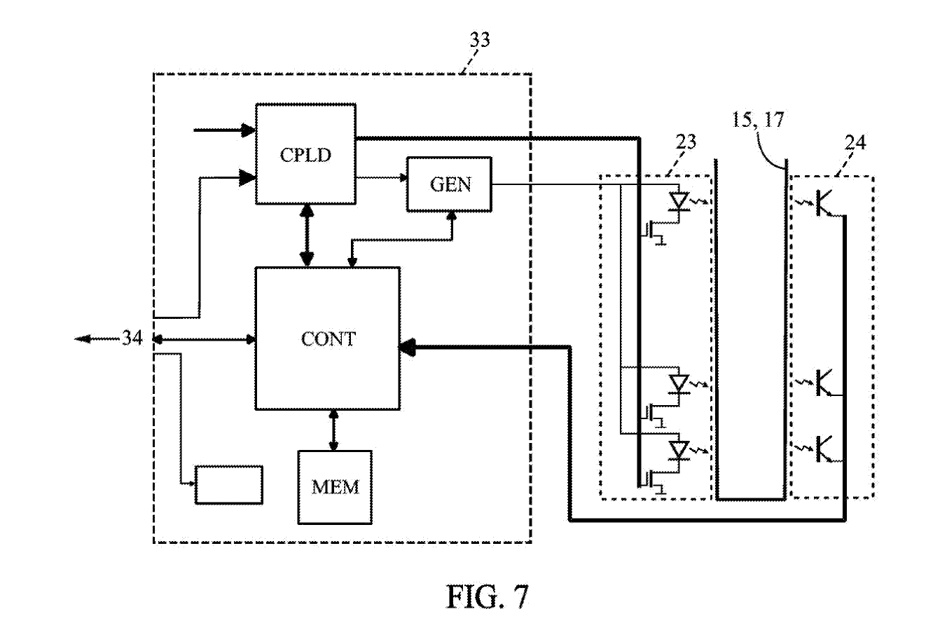

FIG. 7 is a schematic diagram illustrating an embodiment of the electronic assembly of the measuring unit of the preceding figures;

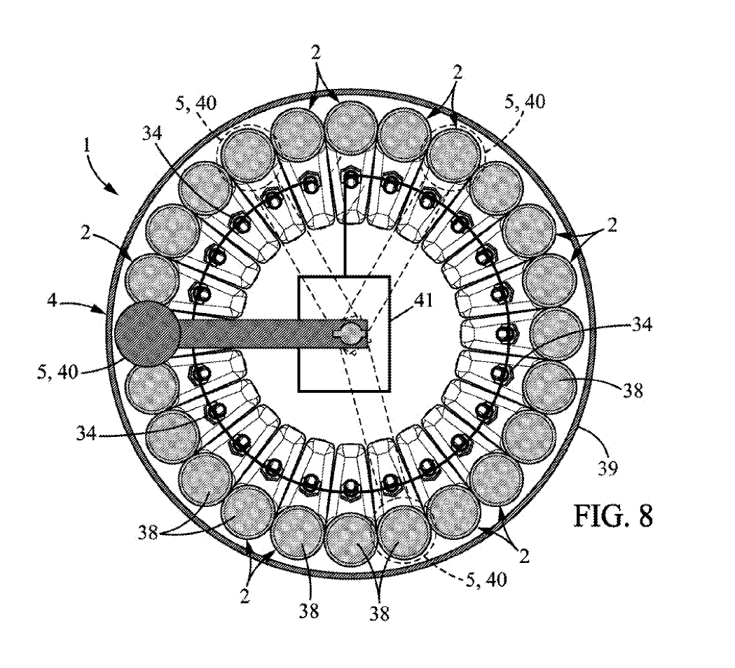

FIG. 8 is a top view of an embodiment example of the measuring device comprising a plurality of measuring units shown in FIGS. 1 to 6;

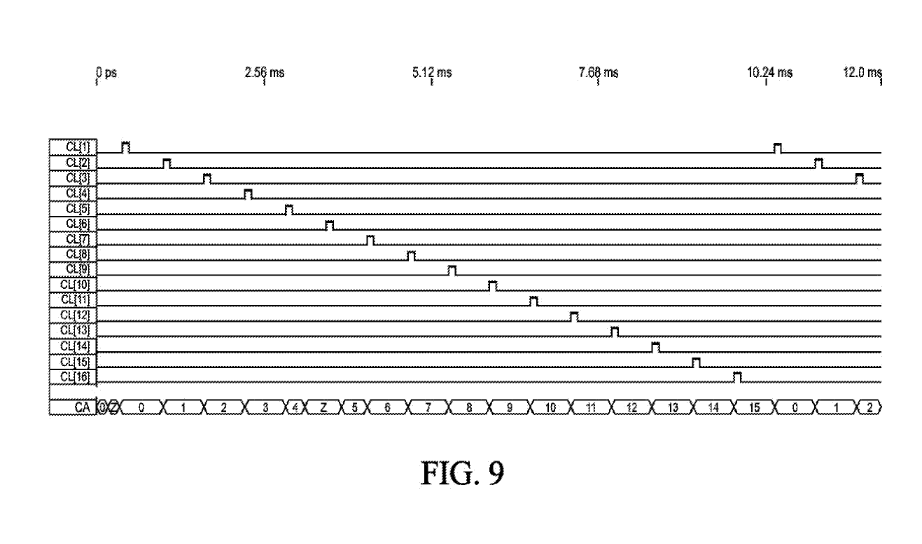

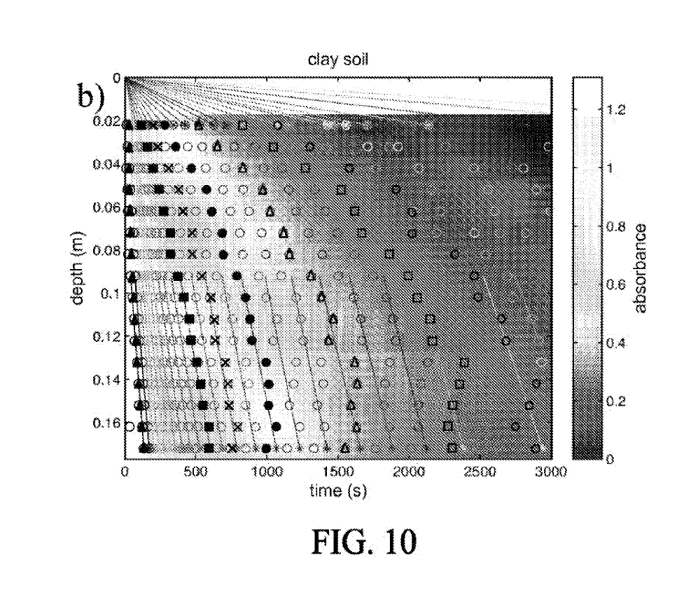

FIG. 9 is a timing diagram illustrating the control of the emitters of the unit in FIGS. 1 to 6;

FIG. 10 is a set of curves representing results obtained with the measuring unit in FIGS. 1 to 6 on a sample comprising particles subject to the phenomenon of flocculation;

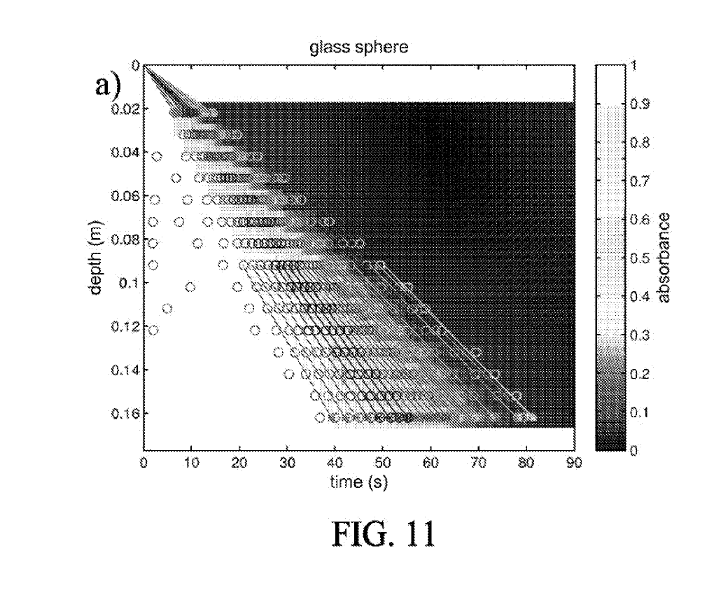

FIG. 11 is a set of curves similar to that in FIG. 10, for a sample containing particles that are not subject to, or barely subject to, the phenomenon of flocculation,

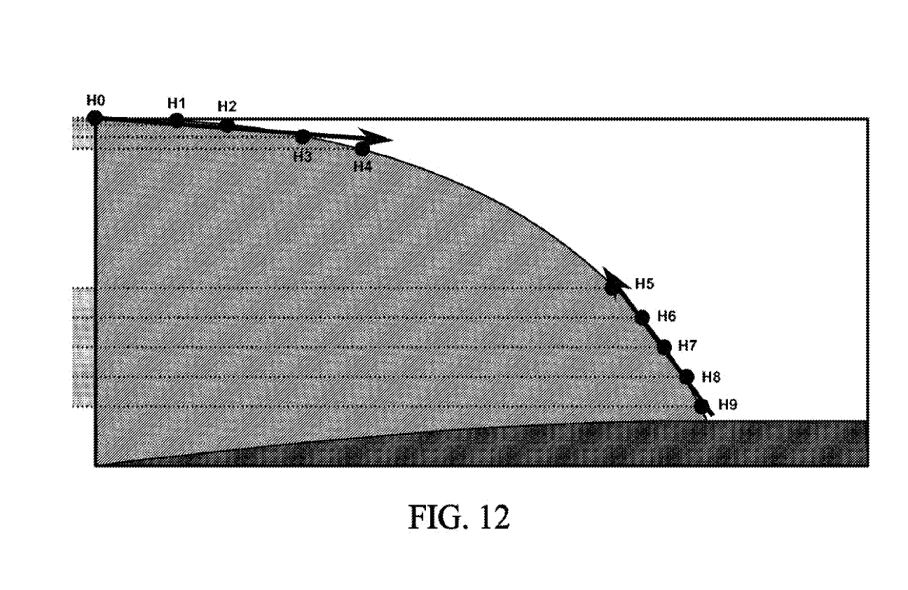

FIG. 12 is a diagrammatic representation of a single curve taken from the diagram in FIG. 10.

The device 1 according to the invention in particular comprises at least one unit 2 for measuring the settling velocity of particles in suspension in a sample 3 of a fluid from a source. The device 1 further comprises an automatic-type sampler 4, which is suitable for use in the field, within which the measuring unit 2 is placed. In practice, and as will be explained later, device 1 comprises a plurality of measuring units 2 placed in the sampler 4. Means for controlling the sampler are provided for this purpose. Sampler 4 comprises a supply system 5 for transporting a sample of fluid taken in the field to the measuring unit 2.

FIGS. 1 to 6 show an embodiment example of a measuring unit 2.

Measuring unit 2 comprises a sealed container 6, defining an internal volume 7. For example, container 6 can be in the form of a container or bottle, and can be made of a thermoplastic material. The container 6 is preferably opaque, i.e. it filters a proportion of visible light. It is in particular water-proof.

More precisely, container 6 is delimited, along a principal axis A, by a distal end 8 and a proximal end 9. The adjectives “distal” and “proximal” are used here with reference to system 5 for the supply of samples to the sampler 4. Thus, the proximal end 9 is closer to the system 5 for the supply of samples to the sampler 4 than the distal end 8.

Moreover, hereinafter, the terms and expressions “upper”, “lower”, “above”, “on”, “below”, “under”, etc. must be understood here in reference to the natural orientation of the figures.

The container 6 is delimited by a side wall 10, extending substantially along the principal axis A, and is closed at its distal end 8 by a bottom 11. The proximal end 9 has an opening 12 giving access to the internal volume 7 of container 6. More precisely, the side wall 10 forms, at the proximal end 9, an upper surface 13 that is surmounted by a neck 12′ forming the opening 12. As will be seen later, the bottom 11 of container 6 is detachable.

According to one example, the side wall 10 of container 6 comprises two flanks 14, extending substantially parallel to the principal axis A, and inclined relative to one another in a plane perpendicular to the extension axis A. Thus, viewed in a plane perpendicular to the extension axis A, container 6 is of sector shape.

At least two compartments are formed in the internal volume 7 of container 6. A first compartment 15 is said to be open as it comprises the opening 12 of container 6, so that this open compartment 8 is accessible via opening 12. The second compartment 16 is said to be sealed, as it is separated hermetically from the opening 12.

According to one embodiment, which is that in the figures, the open compartment 15 is formed by introducing a reservoir 17 into container 6. The reservoir 17 is for example in the form of a column extending along a longitudinal axis L, closed by a bottom 18 at the distal end and having an opening 19 at the proximal end. For example, reservoir 17 is made of glass or of Plexiglas or any other material transparent to visible and infrared light. It is preferably in the form of a tube, cylindrical with a circular base, so that the cylindrical lateral surface of the reservoir 17 does not have a corner or other discontinuity. However, the shape of reservoir 17 is not limited to a cylindrical shape. For example, advantageously, the shape of reservoir 17 is adapted to best match the internal volume 7 of container 6.

For the purposes of measurements of the settling velocities of particles, reservoir 17 has a height, i.e. a dimension along the longitudinal axis L, of several centimetres, preferably above 10 cm (centimetres), and for example 20 cm, with a diameter of 40 mm (millimetres). In general, the volume of the open compartment 15 must not be too small so as to be able to demonstrate the phenomenon of flocculation, while limiting the overall dimensions. It was found that a minimum volume of 100 to 150 ml (millilitre) is satisfactory for the application described here.

The outside diameter of the reservoir 17 is substantially equal to the inside diameter of the neck 12′ of the container 6. The reservoir 17 is then placed in the container 6 in such a way that an upper portion 17′ of the reservoir 17 extends into the neck 12′ and emerges beyond the opening 12, outside container 6. The opening 19 of the receiver is thus accessible from outside of the container 6.

Sealing means 20 are placed between the upper portion 17′ of reservoir 17 emerging outside of container 6 and the neck 12′ of container 6.

For this purpose, the sealing means comprise an add-on sleeve 21 fixed on the neck 12′ of container 6 and covering the upper portion 17′ of reservoir 17 while leaving the opening 19 of reservoir 17 accessible. O-ring seals 36 are placed between the sleeve 35 and the reservoir 14.

Thus, the reservoir 17 defines the open compartment 15, accessible from outside of the container 6 via its opening 19, and separated from the sealed compartment 16 by the cylindrical lateral surface of reservoir 17 and the sealing means 20. Thus, practically the whole of the internal volume 7 corresponds to the sealed compartment 16, the volume defined by the reservoir 17 defining the open compartment 15.

As a variant, the open compartment 15 can be produced as a single piece with the container 6, the sealing means 21 being formed for example by providing a wall inside the container 6, separating the open compartment 15 with the opening 12 of the container 6 and the sealed compartment 16.

Thus, the sealed compartment 16 is inaccessible when the bottom 11 of container 6 and the sleeve 35 are fixed, protecting the measuring means 17 from any contact with the fluid.

Measuring means 22 are placed in the sealed compartment 16 of the container.

The measuring means 22 are of the optical type and are preferably based on measurements by transmission of electromagnetic radiation. Consequently they have no physical contact with the sample in the column 17.

According to a preferred embodiment, the measuring means 22 make it possible to measure the absorbance of electromagnetic radiation passing through the sample 3 in the reservoir 17. For this purpose, the measuring means 22 comprise at least one row of at least three emitters 23, and preferably at least five emitters 23, distributed longitudinally, over the full height of the reservoir 17 and at least one row of receivers 24, distributed similarly, so that each receiver 24 receives the electromagnetic radiation from a corresponding emitter 23, after passing through the reservoir 17. The emitters 23 and the receivers 24 are placed on either side of the reservoir 17, i.e. they are not immersed in the sample 3 in the reservoir 17.

More precisely, the measuring means 22 comprise a support 25 formed from a base 26 and a flange 27. The base 26 and the flange 27 are displaced relative to one another along an axis that is merged, when the measuring means 22 are placed in the container 6, with the extension axis A. The base 26 and the flange 27 are connected rigidly by one or more braces 28, forming a column along the extension axis A. The flange 27 comprises a portion 29 in the form of a collar, with a diameter corresponding to that of the reservoir 17.

The base 26 comprises a receiving zone 30, specially designed for receiving the bottom 16 of the reservoir 14. For example, the receiving zone 30 forms a recess in the base 26, the dimensions of which correspond to those of the bottom 18 of the reservoir 17.

Thus, the reservoir 17 can be placed with its bottom 18 in the receiving zone 30 of the base 26 and held at a different height by the collar 29 of the flange 27.

The measuring means 22 are arranged in a row, for example in the form of an array, of at least three emitters 23, distributed longitudinally over the full height of the reservoir 17, between the base 16 and the collar 29 of the flange 27, and in a row of receivers 24, distributed similarly, also for example in the form of an array, so that each receiver 24 receives the electromagnetic radiation from a corresponding emitter 23, after passing through the sample 3 in the reservoir 17.

More precisely, each emitter 23 emits electromagnetic radiation oriented along a radiation axis R which crosses the reservoir 17, i.e. which is not parallel to the longitudinal axis L. The radiation axis R can be defined as the axis on which the beam of the emitted radiation is centred. For example, the radiation axes R of each emitter 23 are perpendicular to the longitudinal axis L. The wavelength of the electromagnetic radiation from the emitters 18 is selected so as to pass through the side wall of the reservoir 17. For example, a wavelength close to 880 nm (nanometres), in the near infrared, will be selected.

The receivers 24 are distributed similarly to the emitters 23, so that each receiver 24 is able to receive the radiation emitted by an emitter 23 corresponding to it, after the radiation has passed through the reservoir 17 along the radiation axis R. The row of receivers 24 is then for example diametrically opposite the row of emitters 23.

The measuring means 22 also comprise supports 31, 32 for the emitters 23 and for the receivers 24. More precisely, a first support 31 for the emitters 23 is in the form of a printed circuit. The emitters 23 are then for example LEDs (light-emitting diodes) arranged in line on the printed circuit, along the extension axis A. Moreover, the second support 32, for the receivers 24, is also in the form of a printed circuit on which the receivers 24 are arranged in line. The receivers 24 are then for example phototransistors or photodiodes.

The two supports 31, 32 are placed between the base 26 and the flange 27 of the support 25, to which they are fixed rigidly for example by means of screws. The two supports 31, 32 are arranged, transversely relative to the extension axis A, facing one another and a distance apart, so that a transverse space for reservoir 14 is provided between them.

The emitters 23 and the receivers 24 are mounted on their respective supports 31, 32 by the technique called surface mounting (CSM) and flip-chip mounting. More precisely, each support 31, 32 is pierced. Each emitter 23 and each receiver 24 are passed through a hole in their respective support 31, 32, in such a way that they are flush with one side of the support 31, 32. The emitters 23 and the receivers 24 are fixed on the other side of their support 31, 32, for example by soldering.

Thus, each support 31, 32 has a side where the emitters 23 or the receivers 24 are flush with the surface, and this side can be placed closest to the reservoir 17, and in particular its cylindrical wall.

As will be explained later, the emitters 23 are distributed longitudinally in such a way that a first emitter 23a is placed closest to the collar 29 and a last emitter 23b is placed closest to the base 16. By, “first emitter” is meant emitter 23a, the radiation axis R of which that passes through sample 3 in reservoir 17 is the closest to collar 29 of flange 27. By, “last emitter” is meant emitter 23b, the radiation axis R of which is closest to the base 26.

The first emitter 23a is then placed so that the associated radiation axis R is at most 5 cm beneath collar 29. Moreover, the emitters 23 are placed at a longitudinal distance from one another of less than 5 cm, and preferably less than or equal to 1 cm. The reservoir 17 is filled with the sample 3 of fluid to be analysed in such a way that the maximum level of the filling sample 3 substantially corresponds to the collar 29. In this way, even when the maximum sample level is not reached in the reservoir 17, there is always an emitter 23 the radiation radius R of which will be at most 5 cm, and preferably at most 2 cm, beneath the free surface of sample 3 in the reservoir 17. Preferably, the first emitter 23a has its radiation axis R at a maximum longitudinal distance of at most 1 cm beneath the collar 29. Moreover, the longitudinal distance between the base 16 and the last emitter 23b is at most 5 cm, and preferably at most 1 cm.

Thus, almost the whole of sample 3 in the reservoir 17 is passed through by the radiation from the emitters 23 along the longitudinal axis L. For example, the distance between the first emitter 23a and the last emitter 23b represents at least 80% of the total height of the portion of the reservoir between the collar 29 of flange 27 and the base 16.

The emitters 23 are for example of the diode type, and emit pulses of electromagnetic radiation the wavelength of which corresponds to that for which the reservoir 17 is transparent. In particular, the radiation can be in the infrared range. The intensity of the pulses is adjustable, for example as a function of the concentration of particles in the sample 3.

The receivers 24 are then for example of the photodiode or phototransistor type, and produce, starting from the radiation received, an output signal, for example a current or a voltage, the amplitude of which is proportional to the intensity of the radiation received.

Thus, the radiation emitted by an emitter 23 passes through sample 3 in the reservoir 17, so that its intensity is attenuated as a function of the characteristics of the particles, such as their concentration or their size, over the path of the radiation. Several phenomena can cause the attenuation of the radiation intensity, such as absorbance or diffusion.

In fact, electromagnetic radiation is emitted in practice by the emitters 23 at a solid angle of radiation axis R. Moreover, the receivers 24 also have a solid angle of reception of radiation axis R. Consequently, certain particles in sample 3 that are not aligned with the radiation axis R can scatter a proportion of the radiation. The scattered radiation from an emitter 23 can generate a signal on the receivers 24 that are not aligned on the radiation axis R of the emitter 23 in question. In order to ensure that the electromagnetic radiation received by the receivers 24 results mainly, or even exclusively, from the radiation absorbed by the particles in the reservoir 17, the solid angle of the electromagnetic radiation emitted by the emitters 23 as well as the solid angle of the receivers 24 must be as small as possible.

The material of the reservoir 17 as well as its cylindrical lateral surface make it possible to ensure that passage of the radiation through the sample is the main, if not the only cause of the attenuation of the intensity. The attenuated radiation is then received by a corresponding receiver 23, and converted into a signal characterizing the sample 3, or more precisely characterizing the portion of sample 3 passed through by the radiation along the radiation axis R.

The opacity of the container 6 also makes it possible to limit the interference with external luminous radiation, while preserving a certain naked-eye visibility within the container 6, for example for monitoring the equipment.

Each measuring unit 2 further comprises means controlling the emitters 23 and the receivers 24. In particular, according to the preferred embodiment described here, the control means comprise means for synchronization between the emitters 23 and the receivers 24, so that the operation of the emitters 23 is synchronized with one another and measurement of the signals from the receivers 24 is synchronized with the operation of the emitters 23, in a sequenced manner from the first emitter 2a/first receiver 24a pair from the top to the last emitter23b/last receiver 24b pair from the bottom.

Finally, each measuring unit 2 comprises an acquisition system, connected to the receivers 24 for collecting the data of the measurements carried out.

For this purpose, the measuring means 22 comprise a third support 33, also for example in the form of a printed circuit, in particular for supporting in a general way all the control and acquisition equipment necessary for the measurements. Thus, in particular, the third support 33 integrates the means for controlling the emitters 23 and the receivers 24 with the synchronizing means, as well as the acquisition system. FIG. 7 illustrates, in the form of a schematic diagram, the electronic equipment of the measuring unit 2. More precisely, the control means can be in the form of a current generator GEN coupled to a microcontroller CONT. A programmable logic circuit CPLD can be associated with the microcontroller CONT. A memory MEM, for example of the flash type, for storing the results of the measurements can also be associated with the microcontroller CONT. It can for example be in the form of a micro-SD card. The microcontroller CONT and the programmable logic circuit CPLD are connected to electrical connector 34, which is described later, in order to communicate with the outside. Thus, control instructions are transmitted from outside to the microcontroller CONT and to the programmable logic circuit CPLD. The operation of the emitters 23 is controlled by the circuit CPLD, with the current generator GEN supplying the emitters 23. The signals generated by the receivers 24 are transmitted into the microcontroller CONT and are stored in the memory MEM. The signals can then be recovered on the outside via the electrical connector 34.

The third support 33 is fixed rigidly to support 25, and in particular to the base 26 and to the flange 27, by means of screws for example.

The first and second supports 31, 32 are electrically connected to the third support 33, for example by means of a pliable, flexible ribbon connector.

The supports 31, 32, 33 are of relatively small thickness, less than 1 mm, and for example 0.8 mm. The small thickness of the supports 31, 32, 33 and the surface mounting of the emitters 23 and the receivers 25 can significantly reduce the overall space requirement of the measuring means 22 for placing them in the internal volume 7 of the container 6, in the sealed compartment 16.

In order to recover the results of the measurements carried out and recorded by the measuring means 22, the container 6 is equipped, on its upper wall 10, with a sealed electrical connector 34, electrically connected within the container 6 to the third support 33. The electrical connector 34 is available on the outside of the container 6, and makes it possible to connect the measuring unit 2 in order to communicate with a data recovery and processing station. As a variant, wireless communication means can be provided between the measuring units 2 and the recovery station.

An example of mounting the reservoir 17 and the measuring means 22 in the container 6 will now be described.

According to one embodiment, the bottom 11 of the container 6 is first separated from the side wall 10 in order to be fixed to the measuring means 22. More precisely, the base 26 of the support 25 is fixed rigidly by means of screws 35 on the bottom 11 of the container 6. The measuring means 22 are then inserted in the internal volume 7 of the container 6 via its distal end 8, so that the bottom 11 of the container 6 will reclose the container 6. Fixing means of the screw type 36 can be utilized for rigidly fixing the bottom 11 of the container 6 to the side wall 10. A seal 37 is placed between the bottom 11 and the side wall 10 of the container 6 in order to guarantee hermeticity of the sealed compartment 16 of the container 6. The first support 31 and the second support 32 are then placed in such a way that the transverse space between them, for the reservoir 17, is aligned with the opening 12 of the proximal end of the container 6.

The fixing means of the screw type make it possible to separate the bottom 11 from container 6 subsequently, and then fix it again, as many times and for as long as necessary.

The first support 31 and the second support 32 are then distanced from the side wall 10 of the container 6 in the internal volume 7, so that in the case of impact, the supports 31, 32, and therefore the emitters 23 and the receivers 24, do not come into contact with the side wall 10. This limits the risks of damage or misalignment.

The reservoir 17 can then be introduced via the opening 12 of the neck 12′ of the container 6 into its internal volume 7 in order to be arranged between the first support 28 and the second support 29, the bottom 16 of the reservoir 14 coming into contact with the base 26 of the support 25, for example in the receiving zone 30 provided for this purpose. However, it can be envisaged that the reservoir 17 is already installed on the support 25 before introducing the assembly into the container 6.

The upper portion 17′ of the reservoir then emerges from the container 6 via its opening 9. The sealing means 20—sleeve 21 and seals 22—are then positioned between the container 6 and the upper portion 17′ of the reservoir 17.

The sleeve 21 is intended to cooperate with a stopper 38 in order to close the opening 19 of the reservoir 17, for example by engaging a thread of the sleeve 21 with a thread of the stopper 38. Thus, the sample in the reservoir 17 can be isolated, and more generally the complete unit 2 can be isolated and transported, as will be explained later.

The sampler 4 is then associated with the measuring unit 2 so as to be able to fill the reservoir 17 with a sample 3 of a fluid to be analysed, sampled in situ.

The sampler 4 comprises, on the one hand, a fluid inlet, which can be connected fluidically with the source of fluid to be analysed. The source can be for example a river or an estuary. On the other hand, the sampler 4 comprises a fluid outlet connected fluidically with the opening 19 of the reservoir 17. Feed-in means for the fluid, not shown, allow the fluid to be circulated from the source via the fluid inlet to the fluid outlet connected to the supply system 5 in order to fill the reservoir 17. These feed-in means comprise for example a pipe connected to the fluid inlet of the sampler and a pump. The pipe can measure several metres, for example for immersing sufficiently in the source but also so as to be able to easily place the device 1 beside the source.

In practice, the device 1 comprises a plurality of measuring units 2 associated with the sampler 4, for example twenty-four units 2, as illustrated in FIG. 8.

For this purpose, the sampler 4 comprises a tank 39 in which the measuring units 2 are placed so that the containers 6 of the units are joined together, the bottom 11 of the containers 6 being positioned on the bottom of the tank. The sector shape of the side wall 10 of the containers 6 means that they can be arranged in a circle, in the manner of petals (see FIG. 8). The sampler 4 then comprises means for fluidically connecting its fluid outlet with the reservoir 14 of each measuring unit 2.

According to a first embodiment, the supply system 5 of the sampler 4 comprises an arm 40, mounted rotatably about an shaft of tank 39 so as to describe the circle on which the units 2 are arranged. Thus, the arm 40 can be positioned above the opening 19 of the reservoir 17 of each measuring unit 2 for filling the reservoir 17 of each measuring unit 2 successively, on command. FIG. 8 shows the arm 39 in dashed lines in several successive positions. Each measuring unit 2 can then supply the settling velocity of the particles in the sample 3, the set of units allowing the variation of the settling velocity over time to be monitored.

According to a second embodiment, the sampler 4 comprises means for simultaneously filling the reservoirs 17 of all or of a defined proportion of the measuring units 2, making it possible for example to monitor several places of one and the same source at one and the same time. For this purpose, it can be envisaged that the sampler 4 comprises several fluid inlets, each connected to a pipe that is immersed in a different place of one and the same source or of several sources.

The electrical connectors 31 of the measuring units 2 are for example all connected to a data recovery station, which can be positioned within one and the same communication bus 41, further comprising for example the means 5 for controlling the sampler 4. The central communication bus 41 in particular makes it possible to provide the supply to all of the measuring units 2 and to be connected for example to a computer system, by wired or wireless link. In particular, the communication bus 41 makes it possible to recognize each measuring unit 2 individually, for example by means of a unique, internally fixed address. The communication bus 41 also allows instructions to be received from outside and to be communicated to the measuring units 2 in question.

A cover, not shown, can close the tank again, hermetically, but not necessarily so.

Optionally, the measuring units 2 can be isolated one by one, for example so that the sample contained in their reservoir 17 undergoes other analyses. For this purpose, the stopper 38 is provided on the container 6 for sealing the opening 19 of the reservoir 17, and the electrical connector 34 is disconnected from the data recovery and processing station. The isolated measuring unit 2 can thus be removed from the tank 39, for example to carry out a visual inspection of the sample 3 in the reservoir 17 or for the transporting unit 2.

Means for the automatic emptying of the reservoirs 17 can moreover be provided, in order to control or program the emptying of reservoirs 17 for a next cycle of measurements.

Thus, the data are processed unit 2 by unit 2, i.e. sample by sample, allowing monitoring of the variation of the settling velocity for example over time, but also spatially.

An example of the implementation of a measuring unit 2 will now be described.

For this purpose, the reservoir 17 of the unit 2 is filled by the automatic sampler 4, for example and not necessarily until the level of the sample 3 reaches the collar 29 of the flange 27.

Using the measuring device 1 thus described, it is possible to measure the settling velocity of particles taking the phenomenon of flocculation into account, in order to quantify this phenomenon.

For this purpose, a sample 3 is introduced into the reservoir 17 of a measuring unit 2 of the device 1.

Starting from a start signal, a measurement cycle is launched. The start signal can be given immediately after introduction of the sample into the column 3 up to the desired maximum sample level, in particular by the sampler 4, or can be given on command from an operator. The signal can also be preset as a function of time, for example.

The start signal is taken into account by the synchronizing means, which then control the emission of electromagnetic radiation by the emitters 23. Each emitter 23, from the first emitter 23a to the last emitter 23b, emits, successively, in turn, a pulse of the radiation, of short duration. The synchronizing means also control the receivers 24, so that each receiver 24 receives the pulse sent by the emitter 23 corresponding to it, after having passed through the sample 3.

As the pulse of radiation from an emitter 23 passes through the sample 3 it is partly absorbed, scattered or deflected, so that only a proportion is received by the corresponding receiver 24. The synchronizing means make it possible to ensure that the radiation received by a receiver 24 corresponds to a pulse emitted by a specific emitter 23. Thus, each signal obtained by a receiver 24 corresponds to a height, i.e. a position along the longitudinal axis, on the reservoir 17. In other words, for each measurement there is a corresponding emitter 23/receiver 24 pair.

Absorbance is considered here to be the main cause of attenuation of the electromagnetic radiation passing through the sample in the column 3.

The signal received by each receiver 24 is then collected by the acquisition system, and then it can be recorded for example in the memory MEM of the measuring unit 2. A signal processing unit, for example in an external computer system, then makes it possible to determine the absorbance of the pulse by the sample 3.

Measurement by absorbance is particularly suitable for samples the particle concentration of which is above one gram per litre and reaches very high values, up to 300 g/L, making the device particularly suitable for measurement of the settling velocity of sediments in media at high concentration, such as mountain rivers or wastewater systems. Moreover, the installation of the emitters 23 and the receivers 24 for carrying out the measurement by absorbance is simple and robust.

More particularly, the means controlling the emitters 23 make it possible to adjust their supply current. For example, the current generator GEN is adjustable. Thus, depending on the expected concentration of particles in the medium to be analysed, it is possible to adapt the current of the emitters 23 accordingly. The measuring unit 2 can therefore be used for a vast range of applications involving concentrations varying from 1 g/L to several hundred g/L.

Several measurement cycles are repeated, so as to obtain the absorbance of the sample 3 as a function of time and height. The cycles can be repeated very quickly after one another. In fact, the pulse emitted by the last emitter 23b at the end of a cycle can be followed almost immediately, in practice a few microseconds later, in any case with an adjustable delay, by a pulse emitted by the first emitter 23a in order to begin the next cycle. The cycles are repeated over periods ranging from a few milliseconds to a minute.

A numerical example will now be described for greater precision, in the case when the sample 3 is a mixture of a fluid and particles in suspension. In particular it is a sample of water comprising sediments in suspension.

FIG. 9 shows the timing diagram of the commands of radiation pulses for a cycle of 10 ms (milliseconds), for a measuring device 1 comprising sixteen emitters 23 distributed regularly over the height of the reservoir 17, and sixteen corresponding receivers 24. The portion of reservoir 17 between the base 26 and the collar 29 of the flange 27 measures about 20 cm in height, and the emitters 23 and the receivers 24 are distributed at 1 cm intervals. Starting from a start signal, a command CL[1] is sent to the first emitter 23a in order to emit a pulse. The duration of a pulse is for example 0.1 ms. A command CL[2] is then sent to the next emitter, and so on, up to a command CL[16] for the last emitter 23b. The time between the end of one pulse of an emitter 23 and the start of the pulse of the next emitter 23 is for example a little more than 0.6 ms.

The receivers 24 thus supply the absorbance as a function of the height on the reservoir 17 and as a function of time.

The measurement of absorbance by each receiver 24 can be improved by also performing a measurement in the absence of emission of radiation by the emitter 23 corresponding to it, immediately after reception of a pulse. The signal obtained without a pulse is then subtracted from the signal obtained with a pulse, making it possible to eliminate any influence of external stray radiation.

FIG. 10 presents a result obtained for measurement cycles repeated over 3000 s, and illustrating the variation in the absorbance of the sample 3 in the measuring unit 2 as a function of time and height on the reservoir 17, zero height corresponding to the maximum level of the sample, i.e. the free surface of the sample in the reservoir 17. The sample analysed is a mixture of water and sediments for a concentration of about 1.5 gram of dry matter per litre of mixture. The radiation axis R of the emitters 23 is perpendicular to the longitudinal axis L of the reservoir 17.

The absorbance decreases with time, indicating that the particles are initially in suspension in the fluid, and then fall to the bottom of the reservoir 17. During a measurement cycle, the absorbance also varies as a function of the height on the reservoir 17, the absorbance being greater towards the bottom 18 of the reservoir 17, where the particles accumulate.

The settling velocity of the particles can thus be determined. In fact, laboratory experiments have demonstrated that it is possible to distinguish classes of particles, i.e. the particles of one class settle at velocities that are different from those of the particles of another class, starting from the specific absorbance of each class: a given absorbance, or in other words iso-absorbance, corresponds to the sum of the absorbances specific to each class of particles. Owing to the plurality of measurement cycles, it is therefore possible for a class of particles to be followed virtually in their descent by monitoring the variation in the total absorbance during the test. At iso-absorbance, a height curve is obtained as a function of time. Six iso-absorbance curves are presented in FIG. 10. Thus, it can be seen that the settling velocity varies as a function of the height. More precisely, it can be seen that the curve comprises, starting from the free surface of the sample 3, in the reservoir 17, a first portion that is substantially a straight line, corresponding to the start of the descent, then a curved portion in a second portion, corresponding to the end of the descent, and characteristic of the flocculation phenomenon.

By way of comparison, FIG. 11 illustrates the results obtained using the measuring device 1 for a sample of water to which glass spheres were added. The glass spheres are chosen precisely because they are not sensitive to the flocculation phenomenon: they do not agglomerate together, owing to the inert nature of the glass. The iso-absorbance curves are substantially straight throughout, from start to end, indicating that the settling velocity does not vary with the height, and therefore that there is no flocculation.

Thus, in general, flocculation can be said to be present when an iso-absorbance curve comprises at least three unaligned points.

More precisely, on an iso-absorbance curve, the tangent to the first measurement point, i.e. to the measurement resulting from the pulse emitted by the first emitter 23a, the highest on the reservoir 17, provides an initial velocity, designated vᵢ. The tangent to the last measurement point, i.e. to the measurement obtained from the pulse emitted by the last emitter 23b, the lowest on the reservoir 17, provides a final velocity, v_{f}.

Based on knowledge of the initial velocity vᵢ, and the final velocity v_{f}, the flocculation phenomenon is demonstrated and quantified: the particles that agglomerate as a result of the flocculation phenomenon have a settling velocity that becomes greater and greater as they agglomerate and become heavier.

It is then possible to quantify the flocculation and characterize a sample by a flocculation index I_{f}.

For example, the flocculation index Iₙ can be constructed to correspond to the relative increase in the settling velocity along an iso-absorbance curve:

$${I}_{f 1} = \frac{{v}_{f} - {v}_{i}}{{v}_{i}} \qquad ( 1 )$$

The initial velocity vᵢ can be determined simply by considering respectively the tangent to the highest point of the iso-absorbance curve, and the final velocity v_{f} can similarly be determined by considering the tangent to the lowest point on the same iso-absorbance curve.

The flocculation index Iₙ is then defined for different absorbances, at the operator's choice, who can himself determine the number of iso-absorbance curves to be considered.

The flocculation index Iₙ can also be determined by a linear adjustment, consisting of determining, for each iso-absorbance, two series of measurements, respectively at times t₀, t₁, t₂, t₃, t₄ and t₅, t₆, t₇, t₈, t₉ and at depths z₀, z₁, z₂, z₃, z₄ and z₅, z₆, z₇, z₈, z₉. For example, z₀ corresponds to the height closest to the free surface of the sample in the reservoir 17 for which a measurement of absorbance is obtained, and z₉ corresponds to the height closest to the bottom 18 of the reservoir 17 for which a measurement of absorbance is obtained. A linear adjustment by the method of least squares is then performed on the two series:

zₙ=vᵢ×tₙ+bᵢ for n=[0, . . . , 4], (2)

zₙ=v_{f}×tₙ+b_{f} for n=[4, . . . , 9], (3)

bᵢ and b_{f} being constants.

The initial velocity vᵢ is then the average calculated by the method of least squares applied to formula (2) and the final velocity o_{f} is then calculated by the method of least squares applied to formula (3). FIG. 10 shows, with solid lines, the straight line representing the initial velocity vᵢ and the straight line representing the final velocity v_{f} for different iso-absorbance curves, the straight lines being obtained by the method of linear adjustment.

In order to apply this method of calculation and obtain reliable results, five measurements must advantageously be recorded for each of the two series. Now, the settling velocity of the particles is in principle lower near the free surface of the sample in the reservoir 17 than at the bottom 18 of the reservoir. Consequently, the difference according to the height of the reservoir 17 between two measurements, i.e. between the measurements by two successive receivers 24, is preferably smaller for the first series of measurements than for the second series of measurements. Thus, the first five emitters 23 can for example be distributed every 0.5 cm starting from the first emitter 23a, and the last five emitters 23 can be more spaced apart, for example every 2 cm, up to the last emitter 23b.

FIG. 12 illustrates this constraint. FIG. 12 is a diagrammatic representation of a curve, extracted from FIG. 10 for example, of the height on the reservoir 17 as a function of time, at iso-absorbance, i.e. the settling velocity for a single class of particles. The formation of the layer of particles at the bottom of the column, through which the pulses do not pass, is also shown in dark grey in FIG. 12. It has been note that the slope of the curve increases as the bottom 18 of the reservoir 17 is approached, due to the phenomenon of flocculation. Thus, for the best characterization of the portion of the curve where the slope is least, i.e. near the free surface of the sample, it is necessary for the emitters 23 and the receivers 24 to be at a small enough distance to obtain the settling velocity reliably. Thus, H0, H1, H2, H3 and H4 indicate the heights at which a measurement is carried out in order to obtain the first series. Conversely, the portion of the curve towards the bottom of the column can be characterized with measurements spaced farther apart, for which H5, H6, H7, H8 and H9 indicate the heights in order to obtain the measurements of the second series.

The flocculation index I_{f1} thus calculated makes it possible to quantify the flocculation precisely, and reflects reality. In fact, for example a flocculation index Iₙ equal to 3 indicates that the particles flocculated at the bottom of the reservoir 17 have a settling velocity increased by 300% near the bottom 18 of the reservoir 17 relative to the measurements near the free surface of the sample 3 in the reservoir 17.

When the difference according to the height of the reservoir 17 between two measurements is too great to allow linear adjustment, an alternative method is based on a single measurement height. It is then no longer a question of obtaining a settling velocity of the particles—the aim is to obtain an underestimate of the latter. For this purpose, an estimated velocity wₙ is associated with each measurement by a receiver 24 with the subscript n. The estimated velocity wₙ is defined as the ratio of the height zₙ of the emitter 23, or of the corresponding receiver 24 since it is at the same height, to the time tₙ at which the signal from receiver n assumes the chosen value of absorbance:

$${w}_{n} = \frac{{z}_{n}}{{t}_{n}} \qquad ( 4 )$$

In practice, when formula (4) is applied for a receiver 24 near the free surface of the sample 3 in the reservoir 17, for example for the first receiver 24a, it is considered that the estimated velocity wᵢ obtained is quite close to the real settling velocity of the particles in this portion of the column. When formula (4) is applied for a receiver 24 near the bottom 18 of the reservoir 17, for example for the last receiver 24b, then the estimated velocity w_{f} obtained does not have physical significance.

However, the estimated velocities wᵢ and w_{f} nevertheless allow a flocculation index I_{f2} to be calculated that has physical meaning:

$${I}_{f 2} = \frac{{w}_{f} - {w}_{i}}{{w}_{i}} \qquad ( 5 )$$

As a variant, the two methods presented above can be combined in order to obtain a more robust flocculation index I_{f3}:

$${I}_{f 3} = \frac{{v}_{f} - {w}_{f}}{{v}_{f}} \qquad ( 6 )$$

Formula (6) does not involve the initial velocity vᵢ or wᵢ , so that it allows the flocculation to be quantified when the measurement of the initial settling velocities vᵢ or wᵢ is unsatisfactory.

The numerical value of the flocculation indices I_{f1}, I_{f2}, I_{f3} obtained from the three formulae (1), (5) and (6) presented above can be different. However, their relative variation is substantially similar. Consequently, even using different formulae for quantifying the flocculation of different materials, it is possible to compare them.

For glass spheres, flocculation indices close to 0, for example between −0.5 and 1, will be obtained. For highly flocculating clay particles, flocculation indices ranging from some tens to some hundreds will be obtained.

The larger the number of pairs of emitters 23/receivers 24, the higher the quality of the results obtained, making it possible to take into account the reality of the flocculation phenomenon. For example, for samples of very high concentration, i.e. several grams per litre, the pulse emitted by the emitters 23 near the bottom of the reservoir 17 passes through a layer of particles already deposited at the bottom of the reservoir. The signal obtained by the corresponding receivers 24 is zero and cannot be used. It is therefore necessary to be able to eliminate the results obtained by these receivers 24, while retaining a sufficient number of receivers 24 for which the signal is usable, outside of the layer of deposited particles.

It follows from the above description that the measuring device 1 can thus be employed in situ, i.e. directly in proximity to the medium to be analysed, in contrast to techniques that are carried out entirely in the laboratory. For example, the device 1 can be placed on the bank of a watercourse, with the automatic sampler 4 filling the reservoir 17 of the measuring units 2 on command.

No transport step is required. The analysis can be performed immediately after sampling, i.e. as soon as the reservoir 17 is filled with a specified quantity of fluid and particles. Thus, the flocculation phenomenon can be detected on a sample reflecting an almost exact image of the medium being analysed. The settling velocity of the particles thus measured is of increased accuracy. In particular, it is possible to see its variation as a function of time and depth.

The time for carrying out a cycle is a few milliseconds, and the next cycle can be undertaken almost immediately, so that particles having high settling velocities, of the order of a centimetre per second, can be analysed using measuring device 1. Since the measuring device 1 can be used over long periods of several hours, it is also suitable for the analysis of particles having lower settling velocities, for example of the order of a micrometre per second, or even lower.

The sample analysed can have a concentration of particles greater than a gram per litre, or even up to several hundred grams per litre, making it particularly suitable for the analysis of watercourses in a mountainous environment. The device 1 can moreover be used for several kinds of media to be analysed, having very different expected concentrations of particles. The device 1 is therefore particularly versatile.

The measuring device 1 is for example in the form of a box incorporating one or more measuring units 2 associated with one and the same sampler 4. The measuring device 1 is therefore particularly easy to transport and can be moved quickly from one analysis point to another.

The device 1 thus proves to be inexpensive, and can be installed outdoors, for example beside a watercourse, without particular precautions, for several days.

Optionally, the tank 39 can form a compartment closed with a cover, protecting the reservoirs 17, the emitters 23 and the receivers 24 from the natural elements, for example external light, rain, wind, or even animals when the device 1 is left in place for several days. Moreover, it is not necessary for the radiation axis R of the emitters 23 to be strictly parallel to the free surface of the sample in the container 6. Thus, it is not necessary to take care in ensuring that the surface on which the device is placed is accurately horizontal.

The in-situ deployment of the measuring device 1 is also easy, as there is no need for additional mounting or for treatment of the sample. Operation of the device 1 does not require a link between the communication bus 41 and an external computer system: once the commands have been transmitted to the communication bus 41, the device 1 is completely autonomous.

The application in which the open compartment 15 of the units 2 is filled by an automatic sampler 4 was described above. The open compartments 15 can however certainly be filled manually if required, for example when installation of an automatic sampler 4 in the field proves difficult owing to the conditions, for example when the current of a river to be studied is too strong.

Each measuring unit 2 can be considered and utilized independently of one another. For example, each unit 2 can be filled independently of the others, so as to allow comparative analyses on the samples taken for example at different times and/or at different places.

Moreover, each measuring unit 2 forms in itself a complete, autonomous measuring instrument for quantifying flocculation. As the filling and emptying of the open compartment 15 can be done automatically, for example by being programmed, the measuring unit 2 does not require the presence of an operator at all in order to carry out the measurements. The measurement data are collected automatically by the acquisition system, and then they are recovered for example by the communication bus 41 or when an operator connects a computer directly to the connector 34 of each unit 2.

Each measuring unit 2 can moreover be utilized easily anywhere in the field without particular precautions and can quickly supply quantification of flocculation, without requiring subsequent treatment of the sample 3 taken, or transport to a laboratory.

The measuring device 1 can be applied for different types of materials in suspension in particle form, in fluids also of varied nature, for various flocculation indices.

Other measurement techniques can be adapted for the measuring device 1, such as measurements of scattering, backscattering or analysis of diffraction patterns.

1. A unit for measuring the settling velocity of particles in suspension in a fluid from a source, the unit comprising:
a sealed container having an opening, the container defining an open compartment that comprises the opening and a sealed compartment, sealing means separating the open compartment from the sealed compartment, the open compartment being intended to contain a sample of the fluid to be analyzed;
means for measuring the settling velocity of the particles of the sample in the open compartment, said measuring means being placed in the sealed compartment of the container, said measuring means being of the optical type and comprising:
at least three emitters of electromagnetic radiation, the emitters being distributed along a longitudinal axis of the open compartment, each emitter being oriented along a radiation axis crossing the open compartment at different heights along the longitudinal axis on the open compartment;
receivers, the number of which is equal to the number of emitters and which are distributed along the longitudinal axis, each receiver being placed in the radiation axis of an emitter, so as to receive the radiation from the corresponding emitter after passing through the open compartment;
means for controlling the emitters and the receivers;
a system for acquiring data connected to the receivers for collecting the data of the measurements carried out,
the data acquired making it possible to obtain the settling velocity of the particles and its variation as a function of the height in the open compartment and as a function of time, said variation quantifying a flocculation of the particles.

2. The measuring unit according to claim 1, in which the data acquired by the measuring means are a measure of the absorbance of the radiation emitted by the emitters and received by each receiver.

3. The measuring unit according to claim 1, in which the emitters are of the light-emitting diode type.

4. The measuring unit according to claim 1, in which the radiation has a wavelength comprised in the infrared.

5. The measuring unit according to claim 1, in which the longitudinal distance between the radiation axis of two successive and adjacent emitters is at most 5 cm.

6. The measuring unit according to claim 1, in which the longitudinal distance between the radiation axis of two successive and adjacent emitters is 1 cm.

7. The measuring unit according to claim 1, in which the open compartment is formed by a reservoir introduced into the container, the sealing means being placed between the reservoir and the container.

8. The measuring unit according to claim 1, in which the bottom of the container is detachable.

9. The measuring unit according to claim 1, comprising means for emptying the open compartment of the at least one measuring unit.

10. The measuring unit according to claim 1, comprising an electrical connector available on the outside of the container, capable of communicating with a data recovery and processing station.

11. A device for measuring the settling velocity of particles in suspension in a fluid from a source, the device comprising:
at least one measuring unit according to claim 1;
a sampler of the automatic type comprising a fluid inlet capable of being connected fluidically with the source of fluid and a fluid outlet connected fluidically with the open compartment of the container of the at least one measuring unit.

12. The device according to claim 11, comprising a plurality of measuring units.

13. The device according to claim 11, in which the sampler is connected fluidically with the open compartment of a measuring unit at the same time and comprises means for moving and for fluidic connection with the open compartment of at least one other measuring unit, the means for controlling the sampler making it possible to control the filling of the open compartment of one or other of the measuring units.

14. The device according to claim 11, comprising a plurality of measuring units, in which the sampler is connected fluidically simultaneously with the open compartments of several measuring units, and the controlling means are able to control the simultaneous filling of the open compartments.

15. The device according to claim 11, comprising a plurality of measuring units, the device comprising a tank forming a receiver for the plurality of measuring units, the sampler being connected fluidically with the open compartment of each of the measuring units.

16. The measuring unit according to claim 1, in which the fluid is water and the particles are sediments.
